(19) United States
(12) Patent Application Publication
(10) Pub. No.: US 2009/0198735 A1
(43) Pub. Date: Aug. 6, 2009

(54) METHOD AND APPARATUS FOR MANAGING USER REGISTRATION ON CE DEVICE OVER NETWORK

(75) Inventors: Hee-seok YU, Suwon-si (KR); Hyok-sung CHOI, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/356,675

(22) Filed: Jan. 21, 2009

Related U.S. Application Data
(60) Provisional application No. 61/025,489, filed on Feb. 1, 2008.

(30) Foreign Application Priority Data
Jun. 25, 2008 (KR) 10-2008-0060231

(51) Int. Cl. G06F 17/30

(52) U.S. Cl. 707/104.1; 707/E17.009

(57) ABSTRACT

A method and an apparatus for managing device users over a network are provided. The method of managing users of a device in which network communication is possible, includes: inputting a request of a device user to manage a device user list; providing a user identifier candidate list including at least one user identifier based on the device user request; and managing the device user list based on a user's selection of at least one user identifier in the user identifier candidate list.

### CROSS-REFERENCE TO RELATED PATENT APPLICATIONS

This application claims the benefit of U.S. Provisional Application No. 61/025,489, filed on Feb. 1, 2008, and priority from Korean Patent Application No. 10-2008-0060231, filed on Jun. 25 2008, in the Korean Intellectual Property Office, the disclosures of which are incorporated herein in its entirety by reference.

### BACKGROUND OF THE INVENTION

1. Field of the Invention

Methods and apparatuses consistent with the present invention relate to user's individual management on a device, and more particularly, to user registration on a device in which network communication is possible, and management of registered users.

2. Description of the Related Art

As consumer electronic (CE) devices are personalized, the preferences of users need to be reflected on devices for common use. Although a user needs to input personal information in order to perform user registration on a CE device, due to the limitation in functionality, mobility, and portability of CE devices, there is a limitation in the ability of an input device or interface of the CE device to input specific personal information.

With the development of personal networks and personalization of CE devices, network communication can be performed in CE devices, and a web service is used for customized personalization of CE devices. Owing to a combination of a web service and a CE device, it is easy to overcome limitations of using an input device or interface of the CE device. As such, a web-registered user who wants to access the CE device through a network and a registered user of the CE device need to be interconnected.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and an apparatus for managing registered users on a device in which network communication is possible and for managing registered users, so as to personalize the device.

According to an aspect of the present invention, there is provided a method of managing device users, including: inputting a request of a device user for managing a device user list; providing a user identifier candidate list comprising at least one user identifier based on the device user request; and managing the device user list based on a user's selection of at least one user identifier in the user identifier candidate list.

The managing of the device user list may include adding the selected user identifier to the user list.

The managing of the device user list may include: selecting at least one user identifier from the user list, and performing an edition process comprising at least one of adding, changing, and deleting information with respect to the selected user identifier.

The method may further include transmitting the device user list based on a request of an external user to receive the user list.

The external user may interconnect the external user and the device user by using the device user list.

In the device user list, information on the user identifier may be edited based on a control by the external user.

The method may further include, when the device user list is updated, transmitting user list update notification information to the external user.

When the device can be connected to a network, the external user may be a network user.

The user identifier may include at least one of a name, a photo, and sound of the device user.

The managing of the user list may include, when there is no user identifier selected by the device user, adding a user identifier that is inputted by using an input interface of the device to the device user list.

According to another aspect of the present invention, there is provided a method of managing device users over a network, including: checking a network identifier of a network user; selecting at least one of a plurality of devices registered over the network; searching for a device user list of the selected device; and interconnecting a device user of the selected device and the network user by using the device user list of the selected device.

In the interconnecting of the device user and the network user, when at least one of a plurality of user identifiers in the device user list of the device is selected, the selected user identifier and the network identifier may be interconnected.

The method may further include performing an edition process comprising at least one of adding, changing, and deleting information with respect to the selected user identifier in the device user list of the device by the interconnected network user.

The obtaining the device user list may include: requesting the device that has been registered over the network for a device user list; and registering the device user list that is received from the device.

The method may further include, when the device is connected to a network, receiving update notification information whenever the device user list of the device is updated.

The method may further include updating the device user list based on the update notification information.

The user identifier may include at least one of a name, a photo, and sound of the device user.

The checking of the network identifier may include, when a network identifier of the network user has not been registered, registering a network identifier of the network user.

The selecting of the device may include: when a plurality of predetermined devices have not been registered, registering the predetermined devices over a network; and selecting at least one of the registered devices.

The network user and the device user may be interconnected through a hub site on a network server.

According to another aspect of the present invention, there is provided a user management system through a network, including: a device, and a network server, wherein the device includes: a user identifier request input unit inputting a request by a device user for managing a device user list of the device; a user identifier candidate list provision unit providing a user identifier candidate list comprising at least one user identifier based on the device user request; a user list management unit managing the device user list based on a user's selection of at least one user identifier in the user identifier candidate list; and a user list transmission unit transmitting the device user list to a server over the network, wherein the network server comprises a device-network user interconnection unit interconnecting a network user using the device through the network and the device user based on the device user list.

The network server may include: a network identifier check unit checking a network identifier of the network user on the network server; a device selection unit selecting at least one of the devices that have been registered in the server; and a user list search unit searching for a device user list of the selected device, and wherein the device-network user interconnection unit interconnects the network user and the selected device user by using the device user list of the selected device.

The device-network user interconnection unit may interconnect a network identifier of the network user and a user identifier in the device user list of the device by using the device user list of the device.

The user list managing unit may input a user identifier other than a user identifier in the user identifier candidate list and adding the inputted user identifier to the user list.

The user identifier may be at least one of a name, a photo, and sound of the user of the device.

At least one of the user identifier candidate list and the user list may be managed by the device user.

At least one of the user identifier candidate list and the user list may be managed by the network user.

The user list management unit may select at least one user identifier from the user identifier candidate list by operating at least one of a plurality of direction keys and a confirmation key.

The network user and the device user may be interconnected through a hub site on the network server.

According to another aspect of the present invention, there is provided an apparatus for managing device users, including: a user request input unit inputting a request by a device user for managing a device user list of the device; a user identifier candidate list provision unit providing a user identifier candidate list comprising at least one user identifier based on the device user request; and a device user list management unit managing a user list based on a user's selection of at least one user identifier in the user identifier candidate list.

The device user list management unit may add the selected user identifier to the device user list.

The device user list management unit may select at least one user identifier from the device user list and performs an edition process comprising at least one of adding, changing, and deleting information with respect to the selected user identifier.

The apparatus may further include a device user list transmission unit transmitting the device user list by a request of an external user to receive the user list.

The external user may interconnect the external user and the device user by using the device user list.

In the device user list, information on the user identifier may be edited based on a control of the external user.

When the device user list is updated, user list update notification information may be transmitted to the external user.

When the device can be connected to a network, the external user may be a network user.

The user identifier may include at least one of a name, a photo, and sound of the device user.

The device user list management unit may add a user identifier that is inputted by using an input interface of the device, to the device user list.

According to another aspect of the present invention, there is provided a computer readable medium in which a program for executing a method of managing device users is recorded, wherein the method comprises: inputting a request for managing a device user list of the device; providing a user identifier candidate list comprising at least one user identifier; and managing the user list based on the user identifier.

The method may further include transmitting the device user list by an external request.

According to another aspect of the present invention, there is provided a computer readable medium in which a program for executing a method of managing device users over a network is recorded, wherein the method includes: checking a network identifier of a network user; selecting a device that has been registered over the network; searching for a device user list of the selected device; selecting a user identifier from the device user list; and interconnecting the selected user identifier of the device user list of the device and the network identifier.

According to another aspect of the present invention, there is provided a computer readable medium in which a program for executing a user management method by using a system comprising a device and a network server, wherein the user management method includes: providing a user identifier candidate list comprising at least one user identifier; managing a device user list of the device by using the user identifier; transmitting the device user list; checking a network identifier of a network user selecting at least one of a plurality of devices that have been registered over the network server; searching for a device user list of the selected device; selecting a user identifier from the device user list; and interconnecting the checked network identifier and the user identifier.

### BRIEF DESCRIPTION OF THE DRAWINGS

The above and other aspects of the present invention will become more apparent by describing in detail exemplary embodiments thereof with reference to the attached drawings in which:

FIG. 1A is a block diagram of an apparatus for managing a device user, according to an exemplary embodiment of the present invention;

FIG. 1B is a block diagram of a user management system including a device and a network server, according to an exemplary embodiment of the present invention;

FIG. 2 is a block diagram for explaining an operation of interconnecting a device user and a network user, according to an exemplary of the present invention;

FIGS. 3A through 3D illustrate on operation of adding and registering a user on a device, according to an exemplary embodiment of the present invention;

FIGS. 4A and 4B illustrate an operation of interconnecting a network user and a device user over a network, according to an exemplary embodiment of the present invention;

FIG. 5 is a flowchart illustrating a method of managing a device user in which network communication is possible, according to an exemplary embodiment of the present invention; and

FIG. 6 is a flowchart illustrating a method of managing a device user over a network, according to another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

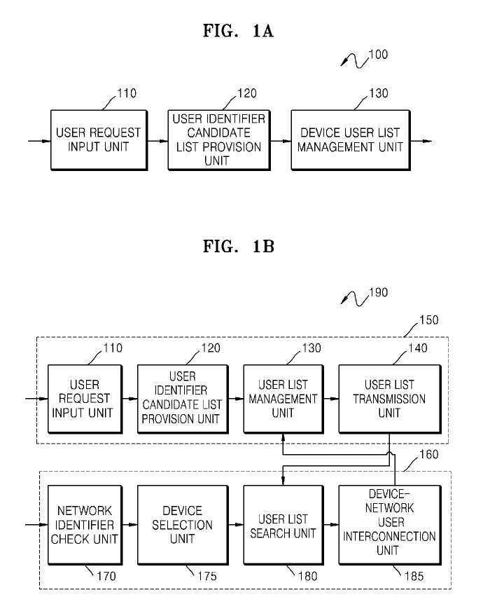

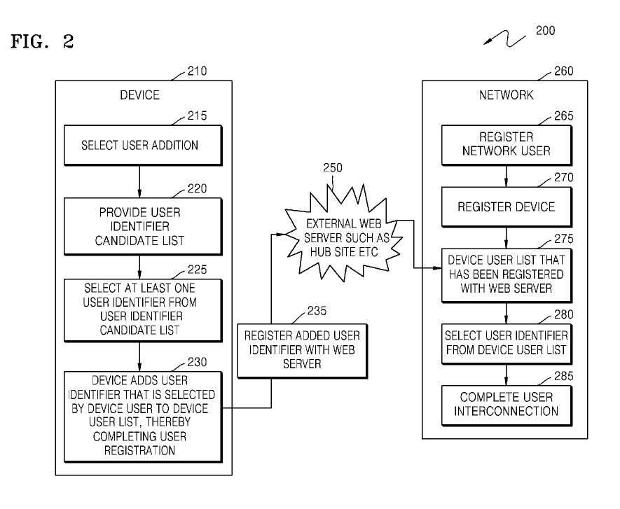

FIG. 1A is a block diagram of an apparatus 100 for managing a device user, according to an exemplary embodiment of the present invention.

Referring to FIG. 1A, the apparatus 100 for managing a device user according to the current exemplary embodiment of the present invention comprises a user request inputting unit 110, a user identifier candidate list provision unit 120, and a device user list management unit 130.

The user request input unit 110 receives a request for managing a device user list from the device user.

The user identifier candidate list provision unit 120 provides a user identifier candidate list including at least one user identifier based on a device user request when a user request for managing the device user list is inputted to the user request input unit 110. The user identifier may be at least one of character information such as device users' names, image information such as a photo, sound information such as sound, etc. For example, when a user identifier listed in a user identifier candidate list is visual data such as a text or an image etc., the visual data can be displayed on a display so that the visual data can be seen by a user.

As described above, the user identifier candidate list provision unit 120 provides a list that has been held by the device in advance, and in the device user list, a user is added by an user addition request using the user identifier candidate list. Also, the user may additionally and directly input a new user identifier to the user identifier candidate list, e.g., by using a device interface. User identifiers that have been included in advance in the user identifier candidate list may be deleted. In addition, user identifiers or user information listed in the device user list that has been generated by an existing ‘user addition request’ may be added, deleted, and changed by other operations performed in the device so that the device user list can be managed at a desired time.

The device user list management unit 130 manages the device user list based on a selected user identifier and outputs the device user list when the user selects at least one user identifier from among the user identifier candidate list provided by the user request input unit 110.

The device user list management unit 130 may generate a device user list when there is no device user list to be managed based on the user identifier selected by the device user. The device user list management unit 130 may add the user identifier selected by the device user to the device user list.

Additionally, at least one user identifier may be selected from among the device user list without selecting a user identifier from the user identifier candidate list so that the device user can edit the device user list. Similarly, the device user management unit 130 may perform at least one edition process including adding, changing, and deleting information on the selected user identifier.

An operation in which the user selects a user identifier from the user identifier candidate list may be completed when direction keys such as up, down, left and right for moving a pointer toward a desired user identifier are activated by using the interface of the device. A pointer reaches a desired user identifier, and at least one user identifier is selected from among a plurality of user identifiers in the user identifier candidate list by using at least one of a plurality of confirmation keys for selecting the user identifier.

The device user list management unit 130 may add the user identifier that is inputted to the device user list by using an input interface included in the device and may change the user identifier when there is no user identifier that is selected by the device user from the user identifier candidate list.

The apparatus 100 for managing a device user may transmit the user list when there is a request from an external user to provide the user list. In this case, the external user may be interconnected to the device user by using the user list received from the apparatus 100 for managing a device user.

The interconnected external user may edit information on the user identifier in the user list. The apparatus 100 for managing a device user may transmit user list update notification information to the external user when the user list is updated. When the device can be connected to a network, the external user may be a user over a network.

When the external user who accesses the device by using the apparatus 100 for managing a device user is a network user, an apparatus 160 for managing a device user over a network may be used. The apparatus 160 comprises a network identifier check unit, a device selection unit, a user list obtaining unit, and a device-network user interconnection unit, according to an exemplary embodiment of the present invention.

The network identifier check unit checks a network identifier of the network user. When there is no network identifier, a new identifier may be added and registered.

The device selection unit selects at least one of a plurality of devices registered over the network based on a network user's selection of the checked network identifier. When there is no device registered over the network, a new device may be added and registered.

The user list search unit searches for the device user list of the selected, registered device. More specifically, the user list search unit requests the device user list of the registered device, receives the device user list from the device, and registers the device user list over the network.

The device-network user interconnection unit interconnects the device user and the network user by using the device user list that is searched for and obtained by the user list search unit. The device-network user interconnection unit interconnects the selected user identifier and the network identifier of the network user when at least one network identifier is selected by the network user from among the user identifiers in the device user list, thereby interconnecting the device user and the network user.

The interconnected network user performs an edition process such as adding, changing or deleting information on the user identifier in the device user list using the apparatus 100 for managing a device user over a network, thereby editing the device user list. In this case, the device user list registered over the network may be edited, and the device user list edited over the network may be reflected on the device. As another exemplary embodiment, the network user may access the device, thereby editing the device user list.

The apparatus 100 for managing a device user over a network may receive update notification information to be transmitted whenever the device user list is updated. The device user list may be updated based on the updated notification information. The device list that is updated on the device may be registered over the network, and only the updated information in the device user list is transmitted from the device. The updated information is reflected on the device user list over the network so that the device user list can be updated.

In the apparatus 100 for managing a device user over a network, the network user may access the device through a hub site on the network server, and a process of interconnecting the network user and the device user, a user list edition process etc. may be performed.

FIG. 1B is a block diagram of a user management system 190 including a device 150 and a network server 160, according to an exemplary embodiment of the present invention.

Referring to FIG. 1B, in the user management system 190 according to the current exemplary embodiment of the present invention, the device 150 may be managed by a user through network communication, and the network server 160 grants access to the device. The device 150 may include a user request input unit 110, a user identifier candidate list provision unit 120, a user list management unit 130, and a user list transmission unit 140. The network server 160 may include a network identifier check unit 170, a device selection unit 175, a user list search unit 180, and a device-network user interconnection unit 185.

The user request input unit 110, the user identifier candidate list provision unit 120, and the user list management unit 130 of the device 150 may correspond to similar elements of the apparatus 100 for managing a device user described above. The network identifier check unit 170, the device selection unit 175, the user list search unit 180, and the device-network user interconnection unit 185 of the network server 160 may correspond to the network identifier check unit, the device selection unit, the user list search unit, and the device-network user interconnection unit of the apparatus for managing a device user over a network described above, respectively.

The user interconnection process using the device-network user interconnection unit 185 is performed by interconnecting the network identifier indicating the network user and the user identifier of the device user list when the user identifier in the device user list that is registered by the network user over the network server 160 is selected.

Since the device-network user interconnection unit 185 uses the device user list that is obtained by the user list search unit 180 through a network, the network user may check the user identifier that is generated in the device and may select the user identifier.

The device user list and the user identifier candidate list may be edited or managed on the device by using the interface of the device, etc. as described above. However, the device user list and the user identifier candidate list may be edited or managed by the network user who is registered over the network.

As described above, the operation of the network user on the network server 190 may use a hub site on the network server.

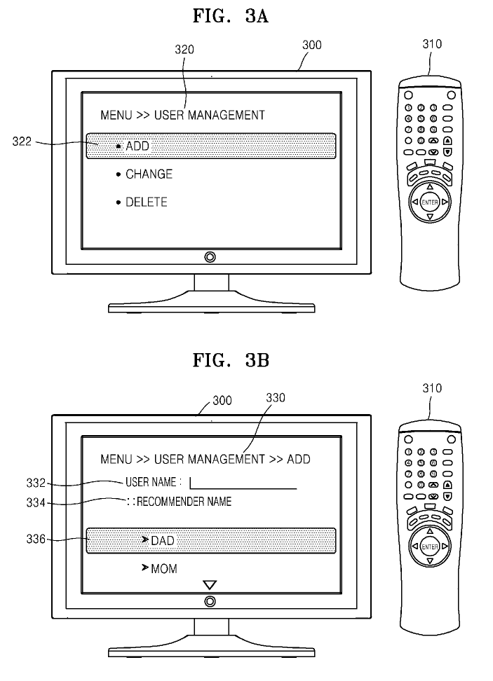

FIG. 2 is a block diagram of a network environment 200 for explaining an operation of interconnecting a device user and a network user, according to an exemplary embodiment of the present invention.

Referring to FIG. 2, the network environment 200 may include a device user 210, an external web server 250, and a network user 260. The network environment 200 establishes communication between a device and at least one user over a network.

The device user 210 selects or requests user addition input so as to register a user in a device in operation 215. According to the current exemplary embodiment of the present invention, when a user registration addition instruction is received from the device user 210, a user identifier candidate list is provided by the user identifier candidate list provision unit 110 of the apparatus 100 for managing a device user in operation 220. The device may be reproduced or represented in an appropriate manner based on the characteristic of each user identifier provided so that the user 210 can recognize the user identifier candidate list. In other words, when the user identifier is a visual object, the visual object may be displayed on a screen, and when the user identifier is an auditory object, a sound source may be reproduced.

The device user 210 selects at least one user identifier from the provided user identifier candidate list in operation 225. The device adds the user identifier that is selected by the device user 210 to the device user list in operation 230, thereby completing user registration. Hereinafter, for convenience of explanation, the device user list that is generated by the device is referred to as a ‘first device user list’. When there is no first device user list that has been generated by the device, the device generates a first device user list and inserts the user identifier in the first device user list.

As another exemplary embodiment of the present invention, instead of providing the user identifier candidate list from the device, the user may wait to directly input the user identifier through the interface of the device, and when the user identifier is directly inputted, the user identifier may be added to the first device user list. A management operation including generating and changing of the first device user list as described above is performed by a user list management unit 130.

The user identifier that is added by user input is registered in the web server 250 in operation 235. The device user list in which only the user identifier added to the device user list on an already-registered web server is additionally inserted or newly generated or changed, may be registered in the web server 250. Hereinafter, for convenience of explanation, a device user list that is registered on the web server 250 is referred to as a ‘second device user list’.

The network user 260 registers the network user in the web server 250 so as to communicate with the device in operation 265. For example, the network user 260 may perform user registration by logging into a hub site for accessing the device through network communication by using a network identifier. The network user 260 who has registered in the web server 250 registers the device in the web server 250 to communicate in operation 270. When at least one device has been registered in the web server 250, at least one device may be selected from among the registered devices.

The network user 260 receives the second user list that has been registered through the web server 250 on the selected device in operation 275. As the device performs management including generating and adding of the second user list as described above, the second device user list is displayed or reproduced based on the characteristic of each user identifier so that the network user 260 can recognize the user identifier in the second device user list.

The network user 260 selects a necessary user identifier from the second device user list of the device. The network identifier of the network user 260 and the user identifier selected by the network user are connected to each other so that the network user 260 and the device user 210 are interconnected in operation 285.

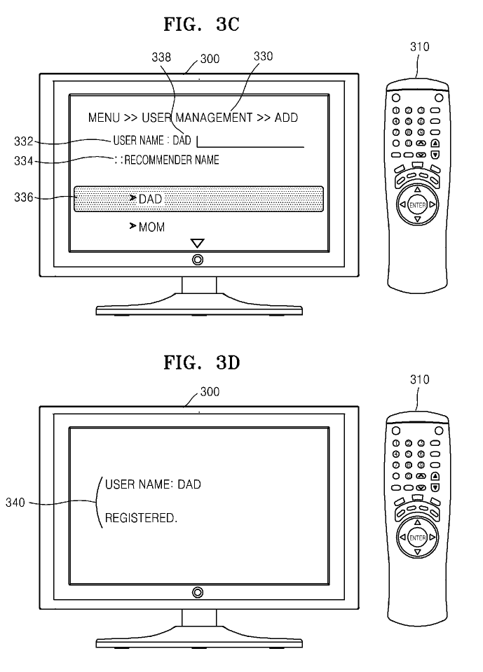

FIGS. 3A through 3D illustrate an operation of adding and registering a user on a device 300, according to an exemplary embodiment of the present invention.

Referring to FIG. 3A, network communication is possible in the device 300 according to the current exemplary embodiment of the present invention. In the current exemplary embodiment of the present invention, a user may use a remote controller 310 as an interface. The remote controller 310 includes direction keys (at least one of direction keys (‘↑’ key, ‘↓’ key, ‘→’ key, and ‘←’ key) and a confirmation key (‘Enter’ key). When the device 300 requests management of user registration, a user management window 320 is displayed, and one of addition, change, and deletion menus, which are submenus of a user management menu, may be selected.

Referring to FIG. 3B, it is assumed that an addition menu 322 is selected from among the submenus of the user management menu. A user name input section 332 and a recommender name item 334 are displayed on a user registration addition window 330. In the example of FIG. 3B, the recommender name includes a user identifier indicating a family member such as ‘dad’ or ‘mom’ as a user identifier in a text format.

Referring to FIG. 3C, the user moves to a desired user identifier from among user identifiers on the recommender name item 334 by using direction keys (‘↑’ key, ‘↓’ key, ‘→’ key, and ‘←’ key) through the interface 310, and when the user reaches the desired user identifier, the confirmation key (‘Enter’ key) is pressed and the user identifier is selected. When the user selects ‘dad’ 336, ‘dad’ is naturally inputted to the user name input section 332. Thus, the user can be registered by minimum input count of the direction keys or the confirmation key so that the user can register a desired user identifier.

Referring to FIG. 3D, the device 300 may indicate that ‘dad’ has been registered in operation 340, and the user may check that a desired user identifier (‘dad’ 336) from the user identifier candidate list (recommender name item 334) has been selected.

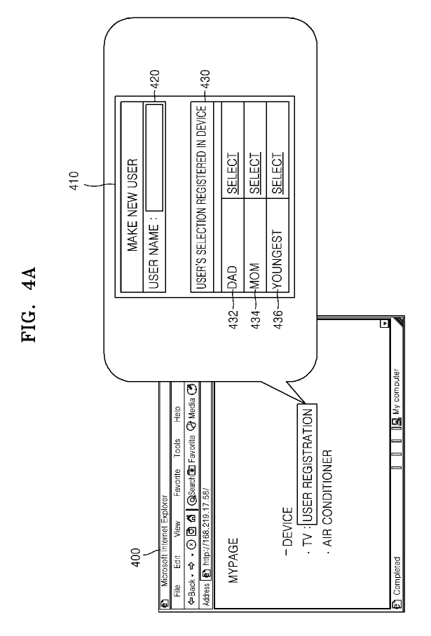

FIGS. 4A and 4B illustrate an operation of interconnecting a network user and a device user over a network, according to an exemplary embodiment of the present invention.

Referring to FIG. 4A, the network user accesses t device by using a hub site 400. When the network user performs user registration in the hub site 400, a user registration management window (‘MY PAGE’ window) is opened, and devices that have been registered for corresponding users are displayed. When user registration is requested so that the user can access a TV, a user registration window 410 is opened.

The user registration window 410 includes a user name input section 420 for user addition and a user identifier selection section 430 in which a desired user identifier can be selected from among already-registered user identifiers. User identifiers that are listed in the device user list (the second device user list of FIG. 2) that has been registered by a device over the network such as a web server, are displayed on the user identifier selection section 430. In other words, ‘dad’ 432, ‘mom’ 434, and ‘the youngest of the family’ 436 are displayed on the device user list, and the network user may select at least one of these user identifiers.

Referring to FIG. 4B, when the network user selects ‘dad’ 432 as a TV user, the hub site 400 may indicate that the network user and the device user ‘dad’ are interconnected on the network in operation 450.

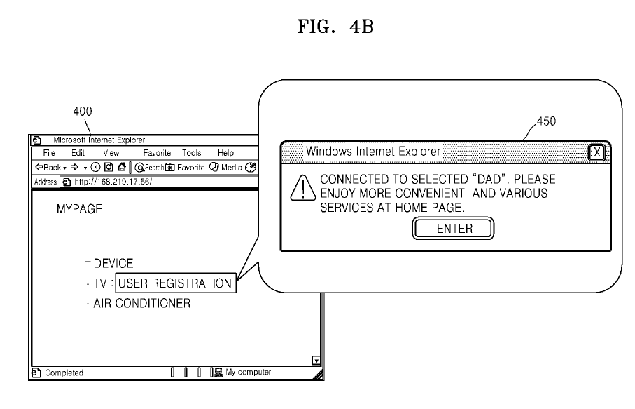

FIG. 5 is a flowchart illustrating a method of managing a device user in which network communication is possible, according to an exemplary embodiment of the present invention.

In operation 510, a request from a device user to manage a device user list is inputted.

In operation 520, a user identifier candidate list including at least one user identifier is provided based on the device user's request.

In operation 530, the device user list is managed based on user selection of at least one user identifier in the user identifier candidate list. When there is no device user list, a device user list of a device including the selected user identifier may be generated. Information on the user identifier in the device user list may be added to, changed, or deleted.

When the user inputs a user identifier other than the user identifier in the user identifier candidate list, the inputted user identifier is added to the device user list so that a new user can be registered. The device user list may be transmitted to an external user by an external request.

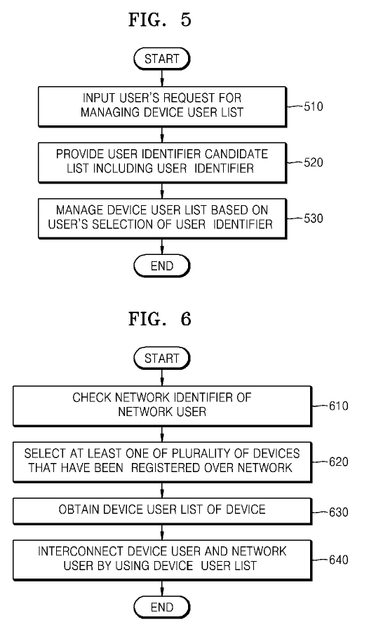

FIG. 6 is a flowchart illustrating a method of managing a device user over a network, according to another exemplary embodiment of the present invention.

In operation 610, a network identifier of the network user is checked.

In operation 620, at least one of a plurality of devices that have been registered over the network is selected.

In operation 630, a device user list of the selected device is obtained.

In operation 640, a device user and a network user are interconnected by using the device user list of the device. The network user who wants to use the device through a network and the device user based on the device user list are interconnected. For example, the network user may be registered over the network server by checking a network identifier, and a device that has been registered in a central server may be selected by the network user. The network user searches for the device user list of the registered device over the network, and when there is no device user list of the device, the network user requests the device to provide a device user list. The provided device user list is registered over the network, and a user identifier is selected from the registered device user list (a second device user list), and the network identifier of the network user and the selected user identifier may be interconnected.

The network user may recognize and select the same user identifier as that of the device user list (a first device user list) that is generated in the device.

In the current exemplary embodiment of the present invention, at least one of the user identifier candidate list and the device user list is managed by a device or a device user but may also be managed by the network user. The network user may access the web server and the device through a hub site.

The invention may also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

The invention may also be embodied as computer readable codes on a computer readable transmission medium which may include carrier waves (such as data transmission through the Internet).

In the method and the apparatus for managing user registration on a device in which network communication is possible and for managing registered users according to the exemplary embodiments of the present invention, the amount of manipulation of an interface or an input device can be minimized for user registration of a device that is necessary for personalizing the device and for management of registered users.

The apparatus according to the exemplary embodiments of the present invention provides a user identifier candidate list for user registration so that registering a new user is convenient and the device user list can be changed over the device or the network.

In addition, various contents such as text, images, sounds, etc. may be used as user identifiers, and the device user list of the device is registered in a network or a web server such that a network user can check and select various user identifiers in the device user list of the device and the device user and the network user can be effectively interconnected.

Accordingly, a method of registering a device user and a method of interconnecting the device user with an online user can be simplified by using a user identifier using various contents.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of managing device users, comprising:
inputting a request of a device user for managing a device user list;
providing a user identifier candidate list comprising at least one user identifier based on the device user request; and
managing the device user list based on a user's selection of at least one user identifier in the user identifier candidate list.

2. The method of claim 1, wherein the managing of the device user list comprises adding the selected user identifier to the device user list.

3. The method of claim 1, wherein the managing of the device user list comprises: selecting at least one user identifier from the device user list; and
performing an edition process comprising at least one of adding, changing, and deleting information with respect to the selected user identifier.

4. The method of claim 1, further comprising transmitting the device user list based on a request from an external user to receive the device user list.

5. The method of claim 4, wherein the external user interconnects the external user and the device user by using the device user list.

6. The method of claim 4, wherein, in the device user list, information on the user identifier is edited based on a control of the external user.

7. The method of claim 4, further comprising, when the device user list is updated, transmitting user list update notification information to the external user.

8. The method of claim 4, wherein, when the device can be connected to a network, the external user is a network user.

9. The method of claim 1, wherein the user identifier comprises at least one of a name, a photo, and a sound of the device user.

10. The method of claim 1, wherein the managing of the device user list comprises, when there is no user identifier selected by the device user, adding a user identifier that is inputted by using an input interface of the device to the device user list.

11. A method of managing device users over a network, comprising:
checking a network identifier of a network user;
selecting at least one of a plurality of devices registered over the network;
searching for a device user list of the selected device; and
interconnecting a device user of the selected device and the network user by using the device user list of the selected device.

12. The method of claim 11, wherein, in the interconnecting of the device user and the network user, if at least one of a plurality of user identifiers in the device user list of the device is selected, the selected user identifier and the network identifier are interconnected.

13. The method of claim 12, further comprising performing an edition process comprising at least one of adding, changing, and deleting information with respect to the selected user identifier in the device user list of the device by the interconnected network user.

14. The method of claim 11, wherein the obtaining the device user list comprises:
requesting the device user list from the device that has been registered over the network; and
registering the device user list that is received from the device.

15. The method of claim 11, further comprising, when the device is connected to a network, receiving update notification information whenever the device user list of the device is updated.

16. The method of claim 15, further comprising updating the device user list based on the update notification information.

17. The method of claim 11, wherein the user identifier comprises at least one of a name, a photo, and a sound of the device user.

18. The method of claim 11, wherein the checking of the network identifier comprises, when a network identifier of the network user has not been registered, registering a network identifier of the network user.

19. The method of claim 11, wherein the selecting of the device comprises:
when a plurality of predetermined devices have not been registered, registering the predetermined devices over the network; and
selecting at least one of the predetermined registered devices.

20. The method of claim 11, wherein the network user and the device user are interconnected through a hub site on a network server.

21. A user management system connected to a network, the user management system comprising:
a device; and
a network server,
wherein the device comprises:
a user identifier request input unit which inputs a request of a device user for managing a device user list of the device;
a user identifier candidate list provision unit which provides a user identifier candidate list comprising at least one user identifier based on the device user request;
a user list management unit which manages the device user list based on a user's selection of the at least one user identifier in the user identifier candidate list; and
a user list transmission unit which transmits the device user list to the network server over the network,
wherein the network server comprises a device-network user interconnection unit which interconnects a network user using the device and the device user through the network based on the device user list.

22. The system of claim 21, wherein the network server comprises:
a network identifier check unit which checks a network identifier of the network user on the network server;
a device selection unit which selects at least one of a plurality of devices that have been registered in the network server; and
a user list search unit which searches for a device user list of the at least one selected device, and
wherein the device-network user interconnection unit interconnects the network user and a user of the at least one selected device by using the device user list of the at least one selected device.

23. The system of claim 22, wherein the device-network user interconnection unit interconnects the network identifier of the network user and the user identifier in the device user list of the device by using the device user list of the device.

24. The system of claim 21, wherein the user list managing unit inputs a user identifier other than the user identifier in the user identifier candidate list and adds the inputted user identifier to the user list.

25. The system of claim 21, wherein the user identifier is at least one of a name, a photo, and a sound of the user of the device.

26. The system of claim 21, wherein at least one of the user identifier candidate list and the user list is managed by the device user.

27. The system of claim 21, wherein at least one of the user identifier candidate list and the user list is managed by the network user.

28. The system of claim 21, wherein the user list management unit selects the at least one user identifier from the user identifier candidate list by operating at least one of a plurality of direction keys and a confirmation key.

29. The system of claim 21, wherein the network user and the device user are interconnected through a hub site on the network server.

30. An apparatus for managing device users, comprising:
a user request input unit which inputs a request of a device user to manage a device user list of the device;
a user identifier candidate list provision unit which provides a user identifier candidate list comprising at least one user identifier based on the device user request; and
a device user list management unit which manages a user list based on a device user's selection of the at least one user identifier in the user identifier candidate list.

31. The apparatus of claim 30, wherein the device user list management unit adds the selected user identifier to the device user list.

32. The apparatus of claim 30, wherein the device user list management unit selects the at least one user identifier from the device user list and performs an edition process comprising at least one of adding, changing, and deleting information with respect to the selected user identifier.

33. The apparatus of claim 30, further comprising a device user list transmission unit which transmits the device user list based on a request from an external user to receive the user list.

34. The apparatus of claim 33, wherein the external user interconnects the external user and the device user by using the device user list.

35. The apparatus of claim 33, wherein, in the device user list, information on the user identifier is edited based on a control of the external user.

36. The apparatus of claim 33, wherein, when the device user list is updated, user list update notification information is transmitted to the external user.

37. The apparatus of claim 33, wherein, if the device can be connected to a network, the external user is a network user.

38. The apparatus of claim 30, wherein the user identifier comprises at least one of a name, a photo, and a sound of the device user.

39. The apparatus of claim 30, wherein the device user list management unit adds a user identifier that is inputted by using an input interface of the device, to the device user list.

40. A computer readable recording medium having embodied thereon a computer program for executing a method of managing device users is recorded, wherein the method comprises:
inputting a request for managing a device user list of a device;
providing a user identifier candidate list comprising at least one user identifier; and
managing the user list based on the user identifier.

41. The computer readable medium of claim 40, wherein the method further comprises transmitting the device user list based on an external request.

42. A computer readable recording medium having embodied thereon a computer program for executing a method of managing device users over a network is recorded, wherein the method comprises:
checking a network identifier of a network user;
selecting a device that has been registered over the network;
searching for a device user list of the selected device;
selecting a user identifier from the device user list; and
interconnecting the selected user identifier of the device user list of the selected device and the network identifier.

43. A computer readable recording medium having embodied thereon a computer program for executing a user management method by using a system comprising a device and a network server, wherein the user management method comprises:
providing a user identifier candidate list comprising at least one user identifier;
managing a device user list of the device by using the user identifier;
transmitting the device user list;
checking a network identifier of a network user selecting at least one of a plurality of devices that have been registered over the network server;
searching for a device user list of the at least one selected device;
selecting a user identifier from the device user list; and
interconnecting the checked network identifier and the user identifier in the obtained device user list.
